(19) United States
(12) Patent Application Publication
(10) Pub. No.: US 2008/0098292 A1
(43) Pub. Date: Apr. 24, 2008

(54) Automatic document reader and form population system and method

(75) Inventor: Russell T. Embry, Deer Park, NY (US)

Correspondence Address: GIBBONS P.C., ONE GATEWAY CENTER, NEWARK, NJ, 07102, US

(73) Assignee: Intelli-Check, Inc.

(21) Appl. No.: 11/584,277

(22) Filed: Oct. 20, 2006

(51) Int. Cl. G06F 17/00

(52) U.S. Cl. 715/226; 715/224

(57) ABSTRACT

A system, and method for automatic population of a form with data from an identification document. The system has a computer and an identification document reader or card scanner coupled to the computer. The card scanner is operable to read machine-readable indicia (e.g., magnetic stripe, bar codes) from one or more identification documents (e.g., driver's licenses, credit cards, Government Issued IDs and the like). The system stores at least one population definition that maps at least one identification document field to a form field. At least one machine readable indicia is read from the identification document, the machine readable indicia representing at least one field from the identification document. The authenticity of the identification document is verified and at least one form field is populated with the identification document field based on the population definition.

### FIELD OF THE INVENTION

The present invention generally relates to identification systems for documents. More particularly, the present invention relates to a system and method for reading and/or verifying the authenticity of identification documents such as a drivers' license, credit card or Government issued ID and utilizing the data from such identification documents to populate fields in ancillary documents or forms.

### BACKGROUND OF THE INVENTION

Over the course of years, various attempts have been made to prevent or detect the use of fake identification cards, but not with a great deal of success. In 1986 with the implementation of the Commercial Motor Vehicle Safety Act (legislation aimed at dealing with the ever-growing problem of multiple licenses being held by one driver) a number of security loopholes were identified and a concerted effort was made to tighten up the process and the driver license documents. The American Association of Motor Vehicle Administrators (trade association representing the various license issuing authorities in the United States and Canada) introduced best practices (Uniform Identification Practices Model Program) that eventually became standards (DL/ID Security Framework). These new driver licenses/identification cards have embedded coded, or even encrypted coded information, with machine-readable formats that attempt to conform to the AAMVA standards. The U.S. federal government (Department of Homeland Security) has now passed a law (REAL ID) that will likely impact what the various states are doing not just with their driver license documents but the processes that exist around the issuance.

It is desirable to provide a means to verify the authenticity of identification documents and provide a robust population mechanism that can utilize the data to populate fields in ancillary forms thereby safeguarding businesses/organizations that rely on such information against losses/crimes that may otherwise be encountered in connection with the use of fake identification cards. It is generally known to provide script based keyboard macros with various types of input data to populate forms and/or otherwise assist in data entry. For example, keyboard macros can allow short sequences of keystrokes to substitute for long sequences of commands. Similarly, keyboard scripts can automate repetitive tasks automatically by sending pre-programmed sets of keystrokes and/or data from various input devices. However such scripts and/or macros suffer from several deficiencies. For example, it can be difficult for the user to fashion a robust script that can tolerate a variety of conditions and still function adequately. Often a minor change in a form can cause the script to malfunction. Similarly, a mouse or keystroke input by a user while the script is running can cause erroneous population of data. To this end, the invention encompasses a system and method to verify the authenticity of identification documents and a robust population mechanism that can utilize the data to populate fields in ancillary forms thereby increasing the confidence in the ancillary form. Such forms can include on-line applications for permits, licenses, credit applications and the like.

### BRIEF SUMMARY OF THE INVENTION

The invention is directed to a system and method for automatic population of a form with data from an identification document. The system has a computer and identification document reader or card scanner coupled to the computer. The card scanner is operable to read machine-readable indicia (e.g., magnetic stripe, bar codes, smart card) from one or more identification documents (e.g., driver's licenses, credit cards, Government issued IDs such as Military IDs, passports and the like). The system stores at least one population definition that maps at least one form field to an identification document field. At least one machine readable indicia is read from the identification document, the machine readable indicia representing at least one field from the identification document. The invention verifies the authenticity of the identification document and at least one identification document field is populated into the appropriate form field based on the population definition.

### BRIEF DESCRIPTION OF THE DRAWINGS

For a better understanding of the present invention, reference is made to the following description and accompanying drawings, while the scope of the invention is set forth in the appended claims:

FIG. 1 shows an exemplary system diagram in accordance with the invention;

FIG. 2 shows a block diagram illustrating exemplary operation of a system in accordance with the invention;

FIG. 3 shows a block diagram of an exemplary device controller module in accordance with the invention;

FIG. 4 shows a block diagram of an exemplary Jurisdiction engine module in accordance with the invention;

FIG. 5 shows a block diagram of an exemplary device service module in accordance with the invention;

FIG. 6 shows a block diagram of an exemplary form filler module in accordance with the invention;

FIG. 7 shows a block diagram of an exemplary configuration module in accordance with the invention;

FIG. 8 shows an exemplary display screen showing configuration information with multiple document types in accordance with the invention;

FIG. 9 shows an exemplary display screen showing configuration information for an exemplary Driver's License identification document in accordance with the invention;

FIG. 10 shows an exemplary display screen showing additional configuration information for an exemplary Driver's License identification document in accordance with the invention;

FIG. 11 shows an exemplary display screen showing menu information in accordance with the invention;

FIG. 12 shows an exemplary display screen showing a translation definition for an exemplary Driver's License identification document in accordance with the invention; and

FIG. 13 shows an exemplary display screen showing various system settings in accordance with the invention.

### DETAILED DESCRIPTION OF THE INVENTION

### I. Overview

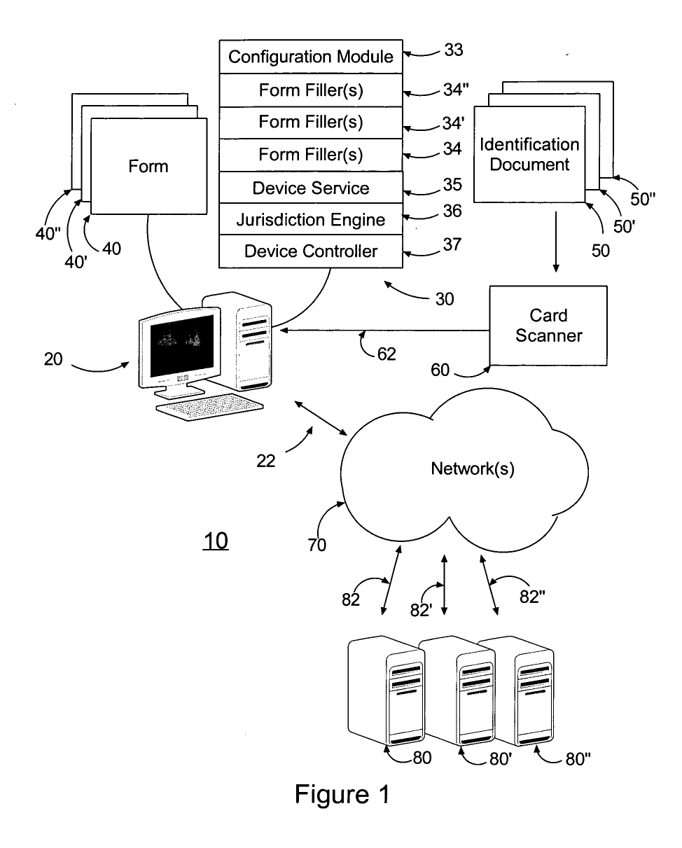

FIG. 1 shows an exemplary system diagram in accordance with the invention. In operation, the system 10 is operable to read one or more identification documents, and utilize the data from such documents to automatically populate one or more fields contained in a form 40. The system 10 has a computer 20 and an identification document reader or card scanner 60 shown coupled to computer 20 via path 62. Card scanner 60 is coupled to computer 20 via conventional means that are well known in the art (e.g., serial, parallel, wired, wireless and the like). Card scanner 60 is preferably operable to read machine readable indicia (e.g., magnetic stripe, bar codes, smart card and the like) from one or more identification documents 50 (e.g., driver's licenses, credit cards, Government Issued IDs and the like). Aside from typical software associated with a computing device such as an operating system, browser and the like (not shown), computer 20 also has associated form filling software 30. In this example, the form filling software is divided into several modules namely, a configuration module 33, one or more form filler modules 34, a device service module 35, a jurisdiction engine module 36, and a device controller module 37.

Computer 20 also has access to one or more forms 40. In this example, each form is associated with a single instance of a form filler module (e.g., 34 and 40, 34′ and 40′, 34″ and 40″ . . . ). It is understood that the precise number of forms 40 and associated form filler modules 34 may vary depending on the particular implementation. Computer 20 is optionally coupled to one or more networks 70 (e.g., LAN, WAN, Internet and the like) via path 22. One or more remote computers or servers 80. 80′, 80″, operable to communicate with computer 20 may also be optionally connected to network 70 as shown by paths 82, 82′, and 82″. The connection between computers (e.g., 20, 80, 80′, 80″) and network 70 can be carried out conventional techniques as is well known in the art.

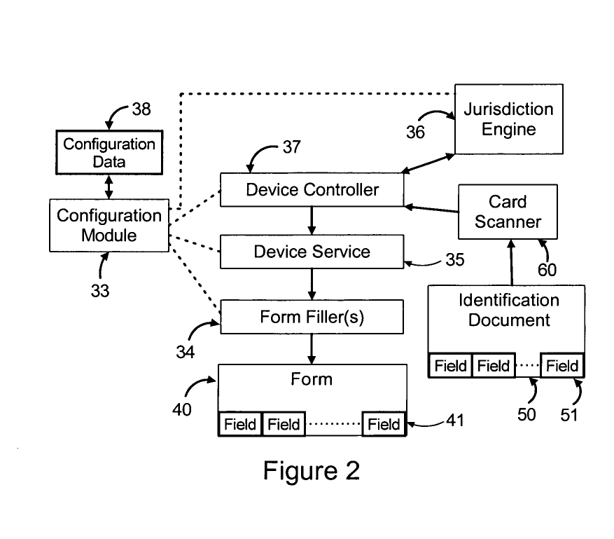

FIG. 2 shows a block diagram illustrating exemplary operation of a system in accordance with the invention. The card scanner 60 is generally operable to read machine-readable indicia from an identification document 50. The identification document 50 includes a set of fields 51 related to the entity subject to identification. In the current example, the card scanner 60 extracts raw data from the identification document (e.g., parsing, data extraction and the like are carried out via other system components). The card scanner 60 sends or communicates the raw data to device controller 37. In the absence of any errors, device controller 37 is operable to communicate the raw data to the jurisdiction engine 36. The jurisdiction engine generally extracts useful portions of data from the raw data and communicates the data and verification status back to the device controller 37. The device controller 37 then communicates the data and verification status to the device service module 35. Assuming no errors are detected, the device service module is operable to receive the data and verification status from the device controller and distribute the data to one or more form fillers 34. The form filler 34 is operable to populate one or more fields 41 (e.g., web form fields) in the form 40. Configuration module 33 can optionally access configuration data 38 and configure or modify various parameters that control, modify or effect operation of the system. A more detailed description of various exemplary system components follows.

### II. Device Controller Module

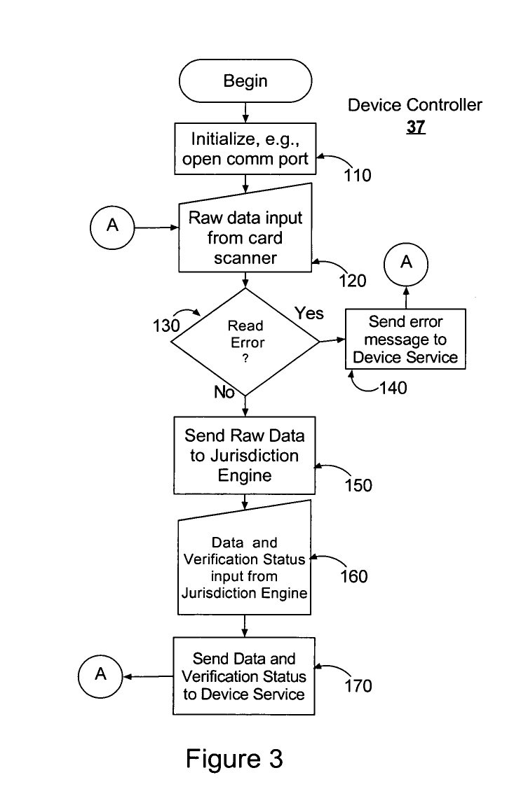

FIG. 3 shows a block diagram of a device controller module 37 in accordance with the invention. In general, the device controller receives data from the card scanner, communicates the data to the jurisdiction engine, receives data and verification status from the jurisdiction engine and communicates the data to the device service module. For matters of clarity, FIG. 3 illustrates only a portion of the device controller module functionality. For example, FIG. 3 is generally depicted as a loop since the device controller typically waits for input before initiating any form of processing. It is understood that other program entry and exit points, time out functions, error checking routines and the like (not shown) would normally be implemented in the device controller. Implementation of these aspects of the device controller are readily apparent and well within the grasp of those skilled in the art.

In the current example, the invention is implemented on a MICROSOFT platform and utilizes Component Object Model (COM) and .NET development technologies. It is understood that the invention can be implemented utilizing one or more of a variety of computing environments (e.g., MICROSOFT WINDOWS family, APPLE MAC OS X, PALM OS, and the like). In the current example, the device controller is implemented as an ActiveX DLL.

Upon initial execution, the device controller module performs typical initialization tasks. These tasks can include initializing various parameters and initialization of any associated hardware and the like, as represented by block 110. In the current example, card scanner 60 is coupled to the computer 20 via a serial port (e.g., USB or RS-232 serial communication port—see FIG. 1). It is understood that other interfaces can be used without departing from the scope of the invention. The device controller utilizes well know techniques (e.g., opening and initialization of a COM port) to establish communication with the card scanner. Configuration and initialization of devices such as a card scanner is well known to those skilled in the art.

Once initialization is complete control passes to block 120, where the device controller waits for raw data input from the card scanner. If the data received from the card scanner is a read error, detected at block 130, an appropriate error message is sent to the Device Service module as represented by block 140. Control is then passed to block 120 and the device controller again waits for data from the card scanner. If the data received from the card scanner is not an error message, the data is then sent or communicated to the jurisdiction engine 36 for further processing as represented by block 150. Control is then passed to block 160 where the device controller waits for data input from the jurisdiction engine (e.g., data and verification status). The data and verification status is then communicated to the device service module 35 as represented by block 170. Control is then passed to block 120 and the device controller again waits for data from the card scanner.

The terms “send” or “communicate” are used in this description in a general sense and are intended to include any type of communication between system components and/or a system user. As outlined above, raw data is communicated from the device controller module to the jurisdiction engine. In the current example, the jurisdiction engine is also implemented as an ActiveX DLL. Accordingly, communication between the device controller and the jurisdiction engine is carried out via ActiveX as is well known in the art. In this example, the device service module is implemented as an ActiveX executable. Accordingly, communication between the device controller and the device service is carried out via ActiveX as is well known in the art.

### III. Jurisdiction Engine Module

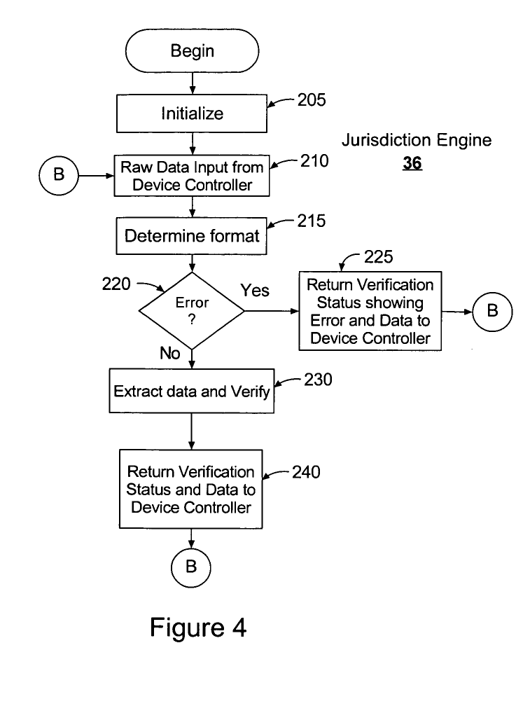

FIG. 4 shows a block diagram of a jurisdiction engine module 36 in accordance with the invention. In general, the jurisdiction engine receives raw data from the device controller, extracts and verifies the data and communicates the data and verification status to the device controller module. For matters of clarity, FIG. 4 illustrates only a portion of the jurisdiction engine module functionality. For example, FIG. 4 is generally depicted as a loop since the jurisdiction engine typically waits for input before initiating any form of processing. It is understood that other program entry and exit points, time out functions, error checking routines and the like (not shown) would normally be implemented in the jurisdiction engine module. Implementation of these aspects of the jurisdiction engine are readily apparent and well within the grasp of those skilled in the art.

The jurisdiction engine can verify the raw data using the techniques disclosed in U.S. Pat. Nos. 5,864,623, 6,463,416, and 6,920,437, which are herein incorporated by reference. For example, typical machine-readable identification documents such as a driver's license contain a set of information fields or segments related to the entity subject to identification. These information fields are organized according to one of a plurality of known formats. The raw data is compared to known organizational formats to determine conformance. Upon making a conformance determination, a particular field can be selected for comparison with a predetermined acceptance criteria. For example, AAMVA compliant documents include an issuing jurisdiction field that is six numeric characters in length, and begins with “6.” Also, other fields can be parsed to determine that they are in the proper format. For example, the fields can be parsed to verify the proper use of delimiters. Some fields can be parsed to verify that the data is within expected ranges.

With reference to FIG. 4, upon initial execution, the jurisdiction engine module performs typical initialization tasks. These tasks can include initializing various parameters and the like, as represented by block 205. Once initialization is complete control passes to block 210, where the jurisdiction engine software waits for data input from the device controller. Once the data is received, it is compared to known organizational formats to identify that particular data format as represented by blocks 215 and 220. If the format cannot be identified, an appropriate verification status is sent to the device controller as shown by block 225. Control is then passed to block 210 and the jurisdiction engine again waits for data from the device controller. If the format of the data received from the card scanner is identified, the data is extracted and verified as represented by block 230. The term “extract” as used herein refers to the parsing of the raw data into the appropriate fields corresponding to the identified format. It is understood that only a subset of data may be utilized for further processing. The following example refers to identification documents encoded with AAMVA magnetic stripe data. It is understood that other machine-readable indicia (e.g., bar codes, smart card and the like) can be utilized without departing from the scope of the invention. Typical AAMVA compliant magnetic stripe data is divided into a plurality of tracks each having a plurality of segments or fields including e.g., Track 1: State, City, Name, Address; Track 2: Issuer Identification Number, Drivers License number, Expiration date, Birth date; Track 3: Version number, Security Version number, Postal code, Vehicle Class, Restriction, Endorsements, Sex, Height, Weight, Hair Color, Eye Color, discretionary data.

The data is then verified or tested for errors (e.g., the identification document is not expired, verify certain values in certain fields such as M, F or 1, 2 denoting for male or female and the like). If an error is detected an appropriate verification status is set. If no error is detected, then an appropriate verification status is set. The data and verification status are then sent to the device controller as shown by block 240. Control is then passed to block 210 and the jurisdiction engine again waits for data from the device controller module.

### IV. Device Service Module

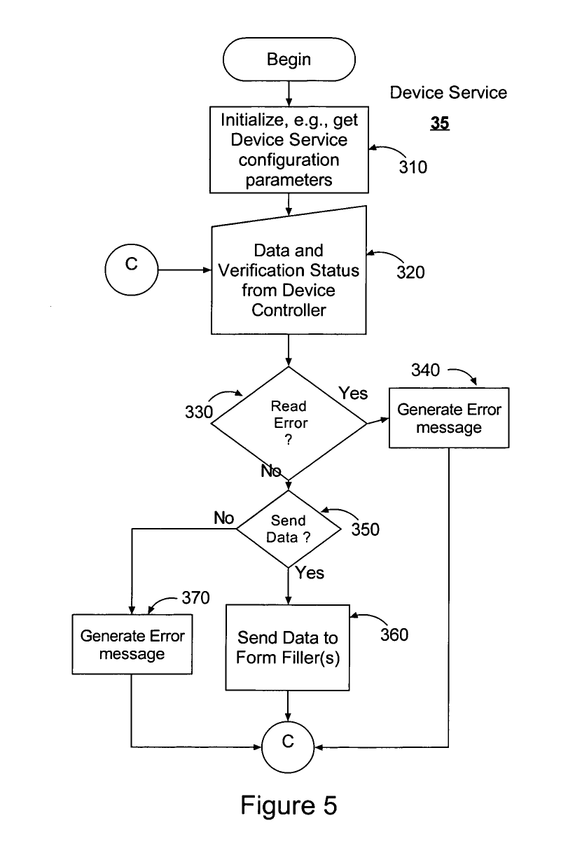

FIG. 5 shows a block diagram of a device service module 35 in accordance with the invention. In general the device service module accepts data verification status from the device controller and (assuming the data is verified) sends or communicates the data to one or more form filler modules. For matters of clarity, FIG. 5 illustrates only a portion of the device service module functionality. For example, FIG. 5 is generally depicted as a loop since the device service typically waits for input before initiating any form of processing. It is understood that other program entry and exit points, time out functions, error checking routines and the like (not shown) would normally be implemented in the device service module. Implementation of these aspects of the device service module software are readily apparent and well within the grasp of those skilled in the art.

Upon initial execution, the device service module performs typical initialization tasks. These tasks can include initializing various device service configuration parameters and the like, as represented by block 310. Once initialization is complete control passes to block 320, where the device service module waits for data and verification status from the device controller. If the data received from the device controller is a read error message (detected at block 330), an appropriate user error message is formatted and displayed to the user as represented by block 340 (e.g., Read Error—please re-swipe card). Control is then passed to block 320 and the device service module again waits for data from the device controller. Block 350 illustrates program control based on a device service parameter. For example, the device service module can be configured to ignore data. For example, the device service module can be configured to ignore data based on a invalid or otherwise undesirable processing result. In the alternative, data can be ignored based on the type of identification document (e.g., credit card). If the device service module is configured to send the type of data received from device controller, then control is passed to block 360. The data is then sent or communicated to one or more form filler modules and control is passed back to block 320. Otherwise, an appropriate user error message (e.g., “Document Verification Failed” or “Please Scan a Driver's License”) is then formatted and displayed to the user as represented by block 370 and control is then passed back to block 320. In this example, each form filler module is implemented as ActiveX DLLs. Accordingly, communication between the device service module and a form filler module is carried out via ActiveX as is well known in the art.

a. Device Service Registration—Connection Class

As discussed above, the device service module is generally operable to accept verified data from the device controller module and communicate the verified data to one or more form filler modules. Before the device controller can communicate with any external modules, the device service module must be able to locate these modules. Utilizing well-known ActiveX techniques, the device service module can provide a connection class to each of these modules. Accordingly, upon initialization of each instance the form filler module requests a connection class from the device service. Similarly, upon initialization the device service module establishes a connection class with the device controller.

b. Exemplary Device Service Parameters

As stated above, the device service module may utilize device service parameters to vary its functionality. These parameters can be stored by techniques that are well known in the art. In the current example, device service parameters are stored in an .ini file that is read during initialization. Several exemplary parameters are shown in Table 1 below:

TABLE 1

| Parameter | |
|---|---|
| Name | Description |
| Enabled | When set to “False”, the Device Service module closes the |
| | Device Controller down. When set to “True”, the system |
| | operates normally. |
| ComPort | Upon initialization, the device service module communicates |
| | the com port number to the device controller module. The |
| | device controller module uses the com port number to connect |
| | to the card reader. |
| Smartcard | Upon initialization, the device service module communicates |
| | this parameter to the device controller module. The device |
| | controller module uses this parameter to “enable (1) or disable |
| | (0)” getting data from a smart card reader device. |
| TimeOut | Amount of time the device service module displays a message |
| | before clearing it. Messages also get cleared if a new “data |
| | event” occurs from the Device Controller or if a new web |
| | page is displayed. |

An exemplary sample from a .ini file pertaining to the foregoing parameters appears below. The exemplary parameters listed below are associated with the “Global” section name since these parameters apply to the entire system.

[GLOBAL]

ENABLED=TRUE

TIMEOUT=1000

COMPORT=4

SMARTCARD=1

It is understood that a wide variety of device service parameters can be utilized without departing from the scope of the invention. The storage, modification and use of parameters such as those set out above is well within the grasp of those skilled in the art.

### V. Form Filler Module

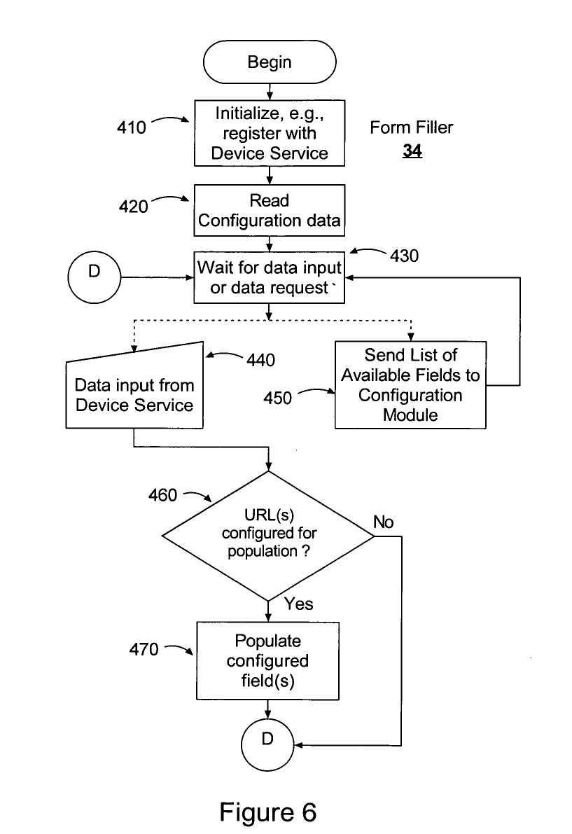

FIG. 6 shows a block diagram of a form filler module in accordance with the invention. In general the form filler module accepts verified data from the device service module and, if configured properly, populates one or more fields from an identification document to the appropriate form field. In the current example, the form filler module is implemented as a Browser Helper Object (BHO) as is well know in the art. In this form, a new instance of the form filler module is created upon the opening of each new browser window and/or frame. Thus the invention is operable to utilize data scanned from a single identification document to populate multiple forms spread across multiple browser windows. For matters of clarity, FIG. 6 illustrates only a portion of the form filler module functionality. For example, FIG. 6 is generally depicted as a loop since the form filler typically waits for input before initiating any form of processing. It is understood that other program entry and exit points, time out functions, error checking routines and the like (not shown) would normally be implemented in the form filler module. Implementation of these aspects of the form filler module software are readily apparent and well within the grasp of those skilled in the art.

Upon initial execution, the form filler module performs typical initialization tasks. These tasks can include establishing a connection class with the device service module (i.e., registering with the device service module), reading the configuration file created by the configuration module (discussed in more detail below), initializing various form filler configuration parameters and the like, as represented by block 410. Once initialization is complete, control passes to block 420 where the form filler reads configuration data previously set by the configuration module. In general, the configuration data specifies the URL(s) having one or more specific form fields to be populated, and which portion or field within the verified data should be used to populate such form fields. A more detailed discussion of field mapping and data translation follows below.

Data input from the device service module is represented at block 440. Once the data is received, control is passed to block 460. If one or more URL has fields configured for population then the form filler populates those fields as represented by block 470 and control is passed back to block 430. A more detailed description of how population is carried out is set out below in the description of the configuration module. The configuration module may request identification of the available fields. Accordingly, this request is handled at block 450. In this example, the configuration module is implemented as .NET module. Communication between the configuration module and the form filler module can be carried out via conventional techniques such as windows broadcast messaging and response via a windows message.

### VI. Configuration Module

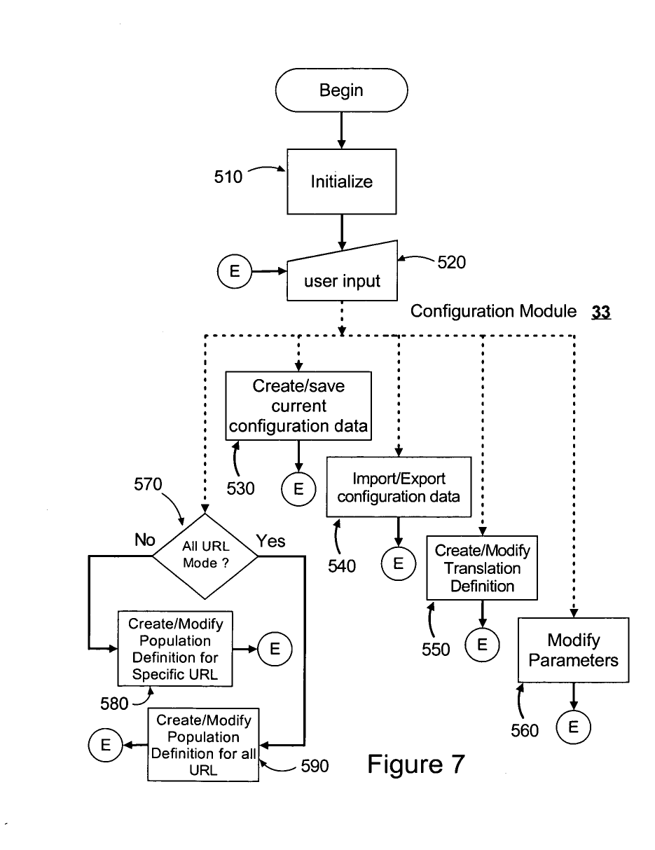

FIG. 7 shows a block diagram of a configuration module in accordance with the invention. In general the configuration module provides a user interface for the invention. The configuration module is utilized to configure URL(s) and/or field(s) for population. The configuration module also provides various utility functions such as the ability to save configuration data, import/export configuration data, create/modify translation definitions and modify parameters. For matters of clarity, FIG. 7 illustrates only a portion of the configuration module functionality. For example, FIG. 7 is generally depicted as a loop since the configuration module typically waits for user input before initiating any form of processing. It is understood that other program entry and exit points, time out functions, error checking routines and the like (not shown) would normally be implemented in the configuration module. Implementation of these aspects of the configuration module software is readily apparent and well within the grasp of those skilled in the art.

Upon initial execution, the configuration module performs typical initialization tasks. These tasks can include reading the configuration file and/or initializing various configuration parameters and the like, as represented by block 510. Once initialization is complete control passes to block 520, where the configuration module waits for user input. Upon receipt of user input (e.g., typically from keyboard or mouse input), control is passed to the appropriate block. As stated above, the configuration module can create a population definition (blocks 570-590), mapping fields associated with an identification document to fields associated with a form such as a web page having one or more form fields. The configuration module can also provide various utility functions such as the ability to save configuration data (block 530), import/export configuration data (block 540), create/modify translation definitions (block 550) and modify parameters (block 560). A more detailed discussion of each of these functions is set forth below.

a. Population Definition

When a user wishes to create or modify a population definition, control is passed to block 570. In this example, basic configuration information is contained in a configuration file, which can contain a variety of data including population definitions, translation definitions, parameters and the like. The configuration file is read by the configuration manager upon start up. In the current example, each instance of the form filler module, upon start up, reads the configuration file. Thus the configuration file provides a mechanism for managing configuration information to be access by several system modules. In general, a population definition can be formatted in different ways. For example, a population definition can be created based on fields appearing in any form (All URL mode). In this mode, if a form has a field with a name matching an existing population definition, the field is populated with the specified data from the identification document regardless of the form name or URL. In the alternative, a population definition can be created based on fields associated with a specific form located a specific URL. Optionally, a population definition can be associated with a specific type of identification document (e.g., driver's license, financial document, military Document . . . ). In the examples that follow, the user has chosen to create a population definition associated with a specific form. Accordingly, control would be passed to block 580 and then back to block 520. It will be readily apparent to those skilled in the art how to create a population definition corresponding to All URL mode.

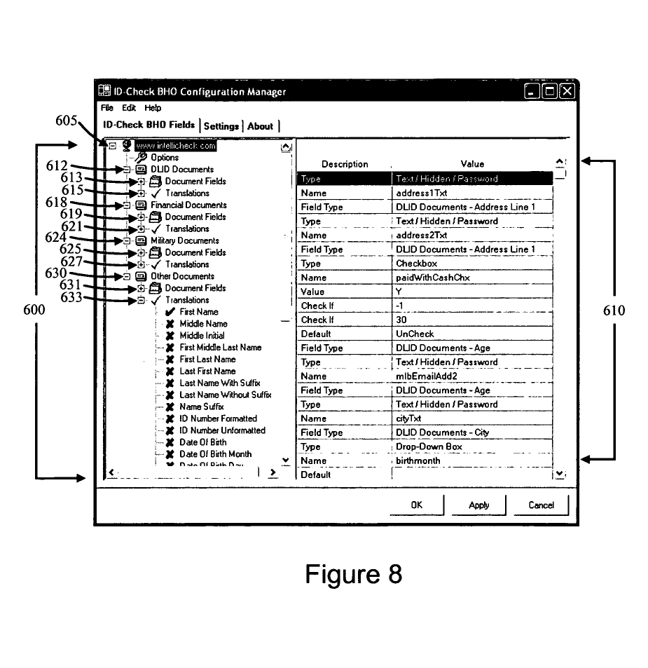

FIG. 8 shows an exemplary configuration manager display screen showing configuration information in accordance with the invention. In this example, the display screen is broken up into a folder view portion 600, and a detail view portion 610. Looking at the folder view portion 600, it is readily apparent that the various population definitions are associated with a form located at a specific URL 605 (www.intellicheck.com). The folder view portion 600 is organized by the type of identification document with folders for driver's license documents 612, financial documents 618, military documents 624 and other documents 630. Each document type is associated with a plurality of identification document fields that are organized by folders 613, 619, 625 and 631. Similarly each document type can be associated with one or more translation definitions (discussed in more detail below) that are organized by folders 615, 621, 627 and 633. Looking at the detail view portion 610, it is readily apparent that details of selected fields and other information can be displayed in this portion as discussed in more detail below.

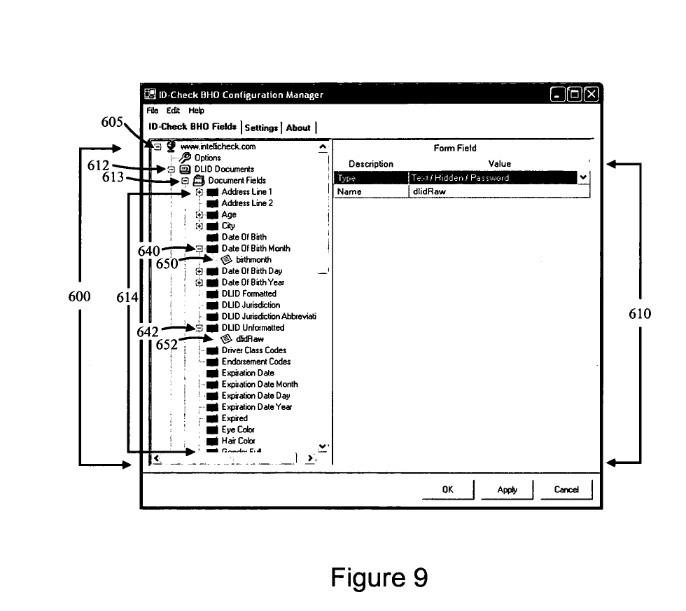

FIG. 9 shows an expanded view of an exemplary drivers license document folder 612 in accordance with the invention. In this example, the document fields folder 613 has been expanded. A portion of the available drivers license document fields are displayed as identification document field folders 614. In this example the Date of Birth Month folder 640 and DLID Unformatted folder 642 are further expanded to reveal associated form field folders 650 and 652. In this particular example the birthmonth form field as shown by 650 is mapped to the Date of Birth Month identification document field as shown by 640. Similarly, the dlidRaw form field as shown by 652 is mapped to the DLID Unformatted identification document field as shown by 642. In this example, the dlidRaw form field was selected by the user. Accordingly, the detail view portion 610 contains details about this particular form field. In this case, the dlidRaw field is a text field. It is understood that a form can contain one or more field types including text fields, check boxes, drop down boxes and the like. The configuration manager is operable to populate each of these field types.

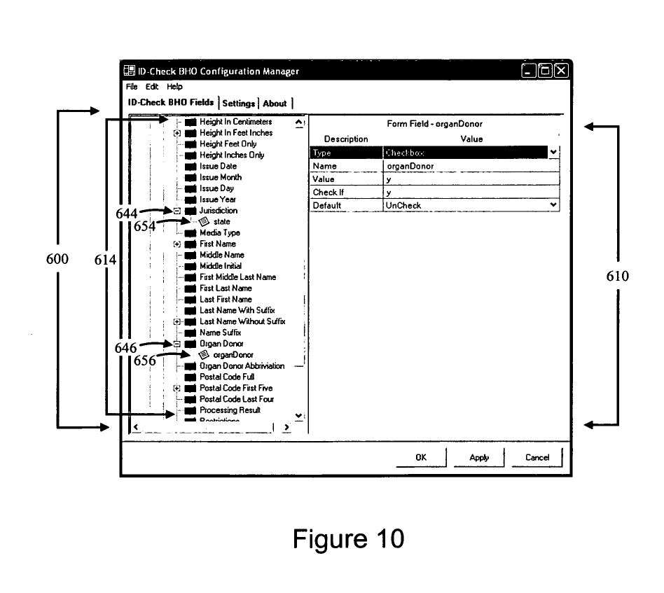

FIG. 10 shows additional population definitions in accordance with the invention. In this example, the state form field as shown by 654 is mapped to the Jurisdiction identification document field as shown by 644. The organDonor form field as shown by 656 is mapped to the Organ Donor identification document field as shown by 646. In this example, the organDonor form field was selected by the user. Accordingly, the detail view portion 610 contains details about this particular form field. In this case, the organDonor form field is a check box field. The box will be checked if the Organ Donor identification document field has a value of “y”. The default for this particular field is unchecked. Accordingly, if the Organ Donor identification document field contains any value other than “y”, the organDonor form field will be unchecked.

In the current example, the configuration module stores one or more population definitions in Extensible Markup Language or XML. It is understood that other file formats, e.g., flat file, .ini file, windows registry, database files and the like can be used to store the configuration file and/or population definitions without departing from the scope of the invention. The configuration module is operable to read and modify the configuration file so that the user can create and modify the rules pertaining to field population. As is well known in the art, XML uses a self-describing and simple syntax. Each element begins with an opening tag and ends with a closing tag that includes the “/” prefix. Elements may have one or more nested sub elements. An exemplary sample of XML code pertaining to the population definitions shown in FIG. 9 appears below.

```
<MappingValues>
<Document>
  <URL>www.intellicheck.com</URL>
    <Date of Birth Month>
      <Value>birthmonth</Value>
    </Date of Birth Month>
    <DLID Unformatted>
      <Value>dlidRaw</Value>
    </DLID Unformatted>
</Document>
</MappingValues>
```

In this example, the population definition is defined by a series of tags associated with (i.e., nested under) the MappingValues XML tag. As is readily apparent, the MappingValues element includes several child elements. One such child element is delimited by the “Document” XML tag, so named because it contains mapping information related to one or more documents. The URL child element contains the URL of the form 40. The term “URL” as used herein generally refers to the address of a form (such as the full path name of a local file, internet address of a web form or the like). In this particular example, the form is located at the world wide web address www.intellicheck.com. In this example, the form 40 contains a form field called “birthmonth”, which can be populated with data from an identification document 50. The “Date of Birth Month” XML tag maps the “Date of Birth Month” ID document field from the identification document 50 to the form field specified by the nested “value” element (“birthmonth”). Similarly, the “DLID Unformatted” XML tag maps the “DLID Unformatted” ID document field from the identification document 50 to the form field specified by the nested “value” element (“dlidRaw”). Based on the foregoing description, it is readily apparent how population is carried out by the form filler module(s).

b. Create/Save Configuration and Import/Export

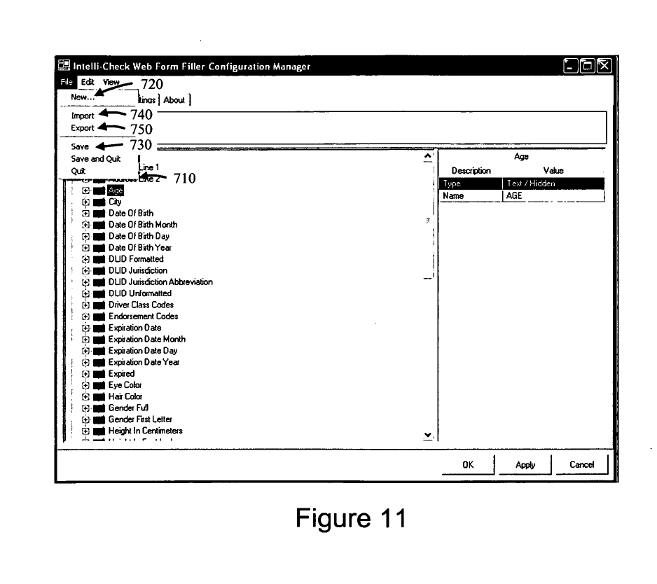

FIG. 11 shows an exemplary display screen showing additional functions in accordance with the invention. The following types of file operations are well known in the art. For matters of completeness, a brief explanation follows. Referring also to FIG. 7, in the event the user wishes to create or save a configuration, as shown by block 530, a file typical menu 710 is provided with the typical options such as new 720 and save 730. Once the selection is made the configuration file is created or saved and control is passed back to block 520. Similarly, if the user wishes to import or export a configuration (e.g., to or from another computer), menu entries 740 or 750 are selected, the desired operation is carried out and control is passed to block 520. If the user elects to import a configuration, the existing XML configuration file is overwritten. If the user elects to export the current configuration, at least a portion of the existing XML configuration file is written to an export file. Once the import/export operation is complete, control is passed to block 520 again.

c. Create/Modify Translation Definition

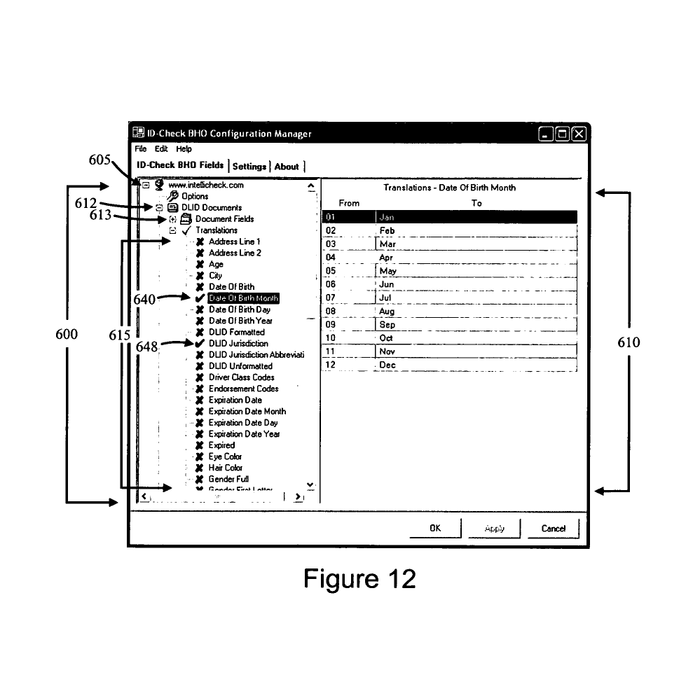

The invention also includes the capability to translate occurrences of text appearing the ID document fields into corresponding text for population in a form field. In the event the user wishes to create or modify a translation definition, as shown by block 550, a corresponding entry is created or modified in the configuration file. Once the translation definition is created or modified, control is again passed to block 520. FIG. 12 shows an exemplary translation definition display in accordance with the invention. In this example, the user has created translation definitions for the Date of Birth Month and DLID Jurisdiction ID document fields as shown by 640 and 648. The user has selected the Date of Birth Month form field. Accordingly, the detail view portion 610 contains details about this particular form field. In this case, the Date of Birth Month form field has a set of translation definitions that translate numeric date information (from a field in the identification document 50) to text information (for population into a field in the form 40). An exemplary portion of XML code associated with the exemplary translation definitions shown in FIG. 12 appears below. It is readily apparent that translation definitions are nested under the “Translation” XML tag:

```
<Translation>
  <Date of Birth Month>
    <From>01</From>
    <To>Jan</To>
  </Date of Birth Month>
  <Date of Birth Month>
    <From>02</From>
    <To>Feb</To>
  </Date of Birth Month>
. . .
    <From>12</From>
    <To>Dec</To>
  </Date of Birth Month>
</Translation>
```

In this example, the ID document field at issue is the “Date of Birth Month” field. The range of expected values for this field is 01-12. The above translation definitions will populate the form field with appropriate text corresponding to the numeric date representation, namely Jan-Dec. For example, in the event the Date of Birth Month field has a value of “01”, this field is translated to “Jan”, as denoted by values enclosed within the nested “From” and “To” tags. In the event the Date of Birth Month field has a value of “02”, this field is translated to “Feb”. It is understood that each of the remaining 12 months has a similar definition (March-November, not shown). It is readily apparent that the ability to translate text in this way provides a simple mechanism for the invention to harmonize a wide range of ID document data with the specific formatting needs associated with a given form. It is also understood that a wide variety of translation definitions can be implement using the techniques disclosed herein.

d. Modify Parameters

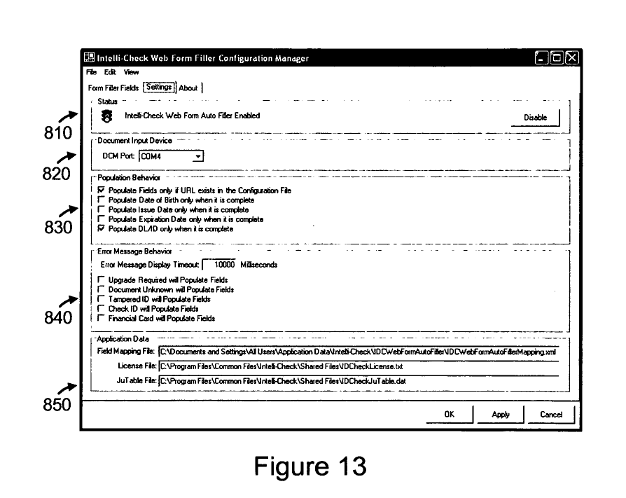

The invention also includes the capability to modify system parameters. The storage, modification and use of parameters is well within the grasp of those skilled in the art. For matters of completeness, a brief explanation follows. In the event the user wishes to modify a parameter, control is passed to block 560. In this event, the desired parameter is modified in the configuration file. It is understood that a wide variety of configuration parameters can be utilized without departing from the scope of the invention. FIG. 13 shows an exemplary display screen showing various system settings in accordance with the invention. Several exemplary categories of parameters are displayed such as those pertaining to: whether the system is enabled 810, the input device port 820 (e.g., DCM Port corresponds to the ComPort parameter discussed above), population behavior 830, error message behavior 840 (e.g., Error Message Display Timeout corresponds to the TimeOut parameter discussed above), and data locations 850.

### VII. Exemplary Applications

Based on the foregoing, it is readily apparent that the invention is suitable for use in a wide variety of applications. The invention is particularly suited for applications in which on-line users (potentially in remote locations) are asked to complete an application form for permits, licenses, credit applications and the like. Such applications are benefited by the data entry aspects of the invention (i.e., less data entry is required by the user and the data is more accurate). The invention can also provide verification of one or more identification document, thereby increasing the confidence in any form populated based on the verified identification document. For example, a financial institution may wish to deploy a plurality of kiosks directed at collecting credit applications or forms 40 (potentially in locations that are remote from the financial institution). Referring again to FIG. 1, in such an example, the kiosk would include a computer 20, card scanner 60 and form filling software 30. The form 40 can reside locally on computer 20 or may be provided via server 80. The user is prompted to scan an identification document 50 using card scanner 60. The raw data is then verified and one or more fields in the form 40 is populated with at least a portion of the verified data. The user can complete any remaining fields that are required to complete the form 40. Once the form is completed is can be transmitted to the financial institution in real time, or batch format via conventional means. Upon receiving the form, the financial institution has increased confidence that the information contained in the completed form is correct.

While the foregoing description and drawings represent the preferred embodiments of the present invention, it will be understood that various changes and modifications may be made without departing from the scope of the present invention.

What is claimed is:

1. A method for automatic population of a form with data from an identification document comprising:
storing at least one population definition that maps at least one form field to an identification document field;
reading at least one machine readable indicia from the identification document, the machine readable indicia representing at least one field from the identification document; and
populating the form field with the identification document field based on the population definition.

2. The method of claim 1, wherein the identification document is at least one of a drivers' license, credit card and a Government issued ID.

3. The method of claim 1, wherein the machine readable indicia is encoded in at least one of a bar code, magnetic stripe and a Government issued ID.

4. The method of claim 1, wherein the population definition is contained in an XML file.

5. The method of claim 1, wherein the identification document includes set of identification document fields related to an entity subject to identification.

6. The method of claim 5, wherein the identification document fields are organized according to one of a plurality of known formats.

7. The method of claim 6, wherein the at least one machine readable indicia is compared to known organizational formats to identify the format.

8. The method of claim 7, wherein upon identifying the format of the at least one machine readable indicia, at least one identification document field can be selected for comparison with a predetermined acceptance criteria.

9. The method of claim 1, further comprising translating the at least one machine-readable indicia based on a translation definition.

10. The method of claim 1, further comprising verifying the authenticity of the identification document.

11. A system for automatic population of a form with data from an identification document comprising:
a computer storing at least one population definition;
a document reader coupled to the computer, the document reader being operable to read at least one machine readable indicia from the identification document, the machine readable indicia representing at least one identification document field; and
a form filler that populates the form field with the identification document field based on the population definition.

12. The system of claim 11, wherein the identification document is at least one of a drivers' license, credit card and a Government issued ID.

13. The system of claim 11, wherein the machine readable indicia is encoded in at least one of a bar code, magnetic stripe and a Government issued ID.

14. The system of claim 11, wherein the population definition is contained in an XML file.

15. The system of claim 11, wherein the identification document includes set of identification document fields related to an entity subject to identification.

16. The system of claim 15, wherein the identification document fields are organized according to one of a plurality of known formats.

17. The system of claim 11, further comprising a translation definition and wherein the form filler that translates the form field based on the translation definition.

18. The system of claim 11, further comprising a jurisdiction engine.

19. A method for automatic population of a form with data from an identification document comprising:
storing at least one population definition that maps at least one form field to an identification document field;
reading at least one machine readable indicia from the identification document, the machine readable indicia representing at least one field from the identification document;
verifying the authenticity of the identification document; and
populating the form field with the identification document field based on the population definition.

20. The method of claim 19, wherein the identification document is at least one of a drivers' license, credit card and a Government issued ID.

21. The method of claim 19, wherein the machine readable indicia is encoded in at least one of a bar code, magnetic stripe and a Government issued ID.

22. The method of claim 19, wherein the population definition is contained in an XML file.

23. The method of claim 19, wherein the identification document includes set of identification document fields related to an entity subject to identification.

24. The method of claim 23, wherein the identification document fields are organized according to one of a plurality of known formats.

25. The method of claim 24, wherein the at least one machine readable indicia is compared to known organizational formats to identify the format.

26. The method of claim 25, wherein upon identifying the format of the at least one machine readable indicia, at least one identification document field can be selected for comparison with a predetermined acceptance criteria.

27. The method of claim 19, further comprising translating the at least one machine-readable indicia based on a translation definition.
